(19) United States
(12) Patent Application Publication
(10) Pub. No.: US 2012/0291879 A1
(43) Pub. Date: Nov. 22, 2012

(54) HANDLING HYDROCARBON CARGOES

(76) Inventor: Simon Mark O'Connor, Poole (GB)

(21) Appl. No.: 13/575,944

(22) PCT Filed: Dec. 22, 2010
(86) PCT No.: PCT/GB2010/002315

§ 371 Date: Jul. 27, 2012

(30) Foreign Application Priority Data
Jan. 29, 2010 (GB) 1001525.3
Oct. 29, 2010 (GB) 1018353.1

(51) Int. Cl. F16K 49/00

(52) U.S. Cl. 137/335

(57) ABSTRACT

The loading of crude oil into a storage tank (12) at A causes vent gas comprising a. mixture of VOC and inert gas to be vented from the tank (12) at C. The vent gas is compressed and delivered at D to a burner (32) of a boiler (34). The burner also receives, at F, a supply of oil (14) as a support fuel to provide stable combustion, the supply of oil (14) being adjusted automatically according to the Wobbe Index and flow rate of the vent gas. Steam generated in the boiler (34) from the burning of the fuels is used to heat the oil (14), to counter waxiness, or for other purposes.

This invention relates to the handling of crude oil or other liquid hydrocarbon particularly but not necessarily on oil tankers or in other oil handling facilities such as floating storage and offloading (FSO) vessels and floating production storage and offloading (FPSO) vessels, or in refineries or other plant producing or using liquid hydrocarbon.

Oil and other liquid hydrocarbon, especially when it is agitated eg during loading or subject to the movement of a tanker at sea, gives off a variety of volatile organic compounds, commonly called VOC, such as methane, ethane, heptane and pentane. (In the absence of a standard international definition, the term VOC is deemed herein to include methane, and if methane is expressly excluded the term NMVOC is used). The release of VOC from the oil gives rise to five notable problems. First, VOC represents a resource which should not be wasted: as much as 0.15% of the load, which in the case of a large carrier could amount to 200 tonne. Second, methane especially is environmentally damaging: as a greenhouse gas, methane is calculated to be 20 or more times as damaging as carbon dioxide. Third, the volatility of these compounds means there is a risk of fire or explosion in the presence of air: to counter this, oil in storage tanks is blanketed with an inert gas such as an exhaust gas mixture which excludes air. Fourth, the VOC commonly carries toxic contaminants such as hydrogen sulphide, heavy metals such as arsenic and barium, and poisonous compounds. And finally, inasmuch as VOC is heavier than air, any discharge to atmosphere from cargo tank vents tends to settle downwards and can trigger gas-sensing alarms at the facility (resulting in the expense of shut-down and evacuation) and/or carry problematic particulate matter into air intakes of machinery.

Of these problems, the risk of fire or explosion is of course particularly serious. To counter this, space in oil storage tanks not occupied by oil is routinely filled with inert gas to provide a blanket that will not propagate flame. As oil is loaded, the inert blanket gas is displaced, mixed with VOC given off by the oil. The mixture is known as vent gas, and those skilled in the art will appreciate that the proportion of VOC in the vent gas increases as loading proceeds. Expressed more generally, vent gas contains varying proportions of VOC and inert gas.

For the avoidance of uncertainty it should be noted at this point that the term “gas” as used herein is intended to include vapour, and the term “gaseous” is to be interpreted accordingly.

Attempts to recover VOC go back many years, most based on liquefying the VOC.

Thus, as long ago as 1922, U.S. Pat. No. 1,490,782 (Milligan) proposed an arrangement in which refrigerant was circulated around a container in the upper part of an oil storage tank to condense and collect the vapour accumulating there. In 1934 U.S. Pat. No. 2,059,942 (Gibson) proposed to refrigerate both oil and the vapour given off from it to cause the vapour to be reabsorbed. In 1943 U.S. Pat. No. 2,379,215 (Brinkmann) also proposed to recover volatile gases and counter this risk of fire or explosion by means of condensation. In 1995 U.S. Pat. No. 5,524,456 (Stokes) proposed to compress and cool vent gas to condense out the VOC, which was then to be stored in separate tanks. And in the same year U.S. Pat. No. 5,678,423 (Davies) proposed to recover VOC from vent gas by compression and separation through a bi-phase rotary separator turbine, the inert gas being vented to atmosphere and the VOC component (or VOC-enriched liquid) being returned to the main cargo.

The first proposal for making active use of recovered VOC, rather than simply returning it to the oil came in 1996, with WO 9740307 (Breivik). This is concerned with the recovery of VOC from crude oil during loading, transit and unloading. Vent gas from the cargo tank is passed to a compressor and then to a hydration unit wherein it is subjected to a hydration reaction in contact with water and under hydrate-forming pressure and temperature conditions. The hydrate so formed is cooled and then stored in the form of a slurry. As and when required on board, the hydrate slurry is heated to release of VOC vapour trapped in the hydrate, and this VOC vapour is then used as an energy source, in engines or in boiler plant. Breivik also indicates that surplus gas remaining after the hydrating process could be combusted.

WO 9833026 (Ruch) describes another approach for recovering and making use of VOC. Ruch shows an arrangement in which VOC gas from crude oil is fed to a processing plant in which at least some of it is compressed and condensed and then passed by way of a cooler to a separator. Liquefied condensate is passed from the separator to an insulated storage tank, from where it may be delivered a “thermal machine” such as a boiler. Non-liquefied gas from the separator is compressed and separately fed to the thermal machine, which may also be supplied with “bunker oil” (also known as heavy fuel oil) as a supplemental fuel.

GB 2396572 (Brødreskift) dates from 2001. It describes a VOC recovery system for use during loading of a tanker in which the displaced gas is compressed and collected in a condensate tank. VOC condensate drawn from the tank is used to fuel a boiler, steam from which is used to drive the compressors of the recovery system. The VOC condensate is the primary fuel for the boiler but this may also be supplemented by heavy fuel oil, and surplus gas—ie what is left over from the VOC condensation and would otherwise be released to atmosphere can also be supplied to the boiler for burning.

Venturi systems offer a way of recovering VOC which is rather different from all the foregoing. One such is described in WO 0208659 (Halse), which concerns a system in which condensed gas is drawn through venturi arrangements through which the oil is also passed, increasing its pressure so that the condensed gas is absorbed. Another venturi system is disclosed in WO 2007086751 (Aasen) in which both oil and gas are fed to an ejector and the gas is swirled for absorption in the oil.

All of the prior art noted above, extending over a period of nearly 90 years, is directed towards extracting VOC from vent gas. It should be noted that extraction of VOC from vent gas does not necessarily extract toxic contaminants at the same time. It should also be noted that until Brievik in 1996 there was no proposal for using extracted VOC to fuel a local boiler, eg on board a tanker or FSO or FPSO. Even then, Breivik required the VOC to be extracted from the vent gas by a process of compression and hydration. And subsequently Ruch required the VOC to be extracted by liquefaction. It may be noted that these proposals—neither of which are known to have been put into practice—were prompted by stringent legislation introduced in Norway to restrict the release of VOC to atmosphere, and were therefore focused principally on preventing atmospheric discharges of VOC rather than on the economic aspects of utilizing VOC. The most recent proposal of this kind comes from Brødreskift, and also demands extraction of VOC from vent gas, with inevitable penalties in cost and complexity. Otherwise recent development has taken a different path with the introduction of absorption systems as proposed by Halse and by Aasen in 2006, neither of which suggests or would readily permit use of the VOC as a boiler fuel.

In all this time nobody has previously perceived that vent gas can be used as a fuel without the added cost and complexity of extracting the VOC.

It is an object of the present invention to enable vent gas to be used as a fuel, for instance in an onboard boiler generating steam to heat oil and facilitate its loading or unloading, and at the same time to ensure that toxic and otherwise hazardous components of the vent gas are destroyed.

As set forth in our copending patent application GB 1001525.3, in a first aspect the invention provides a method of treating vent gas from a store of liquid hydrocarbon, which vent gas comprises a mixture of inert gas and VOC, characterised in that said method comprises burning the vent gas undissociated and in gaseous form to provide a source of heat energy.

It will be noted that this method avoids the need for dissociation (which is to say that the components of the vent gas are not separated, and in particular the VOC is not extracted from the inert gas) or liquefaction of the vent gas (and in particular the VOC is not liquefied) and accordingly provides treatment of the vent gas which is cheaper than offered by the prior art.

The vent gas may be burned in a burner together with a support fuel, which may be the liquid hydrocarbon from which the vent gas has arisen, to provide stable combustion. To ensure stability the amount of support fuel may be adjusted automatically according to the Wobbe Index and flow rate of the vent gas.

The vent gas is preferably burned in the presence of combustion air supplied in an amount not less than that required for stoichiometric combustion. Preferably, also, the vent gas is burned so as to produce combustion products which are substantially less damaging to the environment than untreated vent gas: for instance, it is preferred that substantially all methane in the vent gas supplied to the burner is converted to carbon dioxide plus water, that substantially all hydrogen sulphide in the vent gas supplied to the burner is converted to sulphur dioxide plus water, and that all toxic components of the vent gas are rendered harmless by the burner.

The heat energy may be used to produce steam, to heat the liquid hydrocarbon or for other purposes.

The vent gas may be compressed before being burned, and a proportion of the compressed vent gas may be reabsorbed into the liquid hydrocarbon by vapour absorption.

According to a second aspect of the invention there is provided apparatus for treating vent gas from liquid hydrocarbon, which vent gas comprises a mixture of inert gas and VOC, characterised in that said apparatus comprises a burner operative to burn the vent gas undissociated and in gaseous form together with a support fuel providing stable combustion, a gas conduit for supply of the undissociated vent gas to the burner, a support fuel conduit for supply of the support fuel to the burner and an air conduit arranged to supply combustion air to the burner for combustion of the undissociated vent gas with the support fuel.

The apparatus preferably includes burner control means operative automatically to adjust the amount of support fuel—which may be the liquid hydrocarbon from which the vent gas has arisen—supplied to the burner according to the Wobbe Index and flow rate of the vent gas.

The apparatus preferably includes a compressor operative to compress the vent gas and may also include a return conduit extending from the compressor to a vapour absorption device whereby a proportion of the compressed vent gas is reabsorbed into the liquid hydrocarbon.

The invention is particularly but by no means exclusively useful in providing a convenient means for heating oil, to combat its waxiness, and thus in a third aspect the invention provides a method of heating oil in a tank characterised in that vent gas from the tank, undissociated and in gaseous form, is fed to a burner in a boiler and therein burned with a supply of said oil providing stable combustion, wherein heat energy from the combustion is used to generate steam and the steam is used to heat the oil.

In a fourth aspect the invention provides apparatus for heating oil in a tank characterised in that said apparatus comprises a boiler fired by means of a burner to generate steam, a gas conduit for supply of undissociated vent gas from the tank to the burner to be burned therein, an oil conduit for supply of oil to the burner to be burned therein and provide stable combustion for the vent gas, an air conduit arranged to supply combustion air to the burner for combustion of the undissociated vent gas with the oil, and a steam conduit extending from the boiler to heat the oil.

In a fifth aspect, the invention extends to a burner system for the above defined apparatus, which burner system has a manifold extending axially forward to a firing end and comprising a gas passage, a support fuel passage and a combustion air passage, characterised in that said burner system comprises control means operative automatically to adjust the flow of support fuel according to the Wobbe Index and flow rate of the gas.

The support fuel passage may extend substantially along an axial centreline of the manifold, and for support fuel in liquid form the support fuel passage may include a steam atomiser therefor.

The combustion air passage is preferably divided into a primary air passage and a secondary air passage mutually separated. With this arrangement the primary air passage may be circumjacent the support fuel passage and the secondary air passage circumjacent the gas passage. Also, the gas passage may comprise a plurality of gas ducts arranged circumferentially about the axis of the manifold between the primary air passage and the secondary air passage, and each gas duct may terminate at the firing end in a nozzle inclined to direct the gas forwards and outwards relative to the axis of the manifold.

The secondary air passage is preferably configured and arranged to direct the secondary air forwards and outwards relative to the axis of the manifold. It is also preferred that the combustion air passage terminate at the firing end in an assembly of vanes configured and arranged to swirl the combustion air about the axis of the manifold.

Those skilled in the art of oil handling know that in this art the term ‘inert gas’ refers to a gas or a mixture of gases, such as flue gas, containing insufficient oxygen to support the combustion of hydrocarbons (see eg Inert Gas Systems, International Maritime Organisation, 1990, at paragraph 1.3.1). However the inert gas does not have to be flue gas or the like such as the exhaust from a vessel's engines. In demanding inert gas blanketing, the 1974 International Convention on the Safety of Life at Sea (SOLAS) states at Regulation 62 that the inert gas system ‘shall be capable of providing on demand a gas or mixture of gases to the cargo tanks so deficient in oxygen that the atmosphere within a tank may be rendered inert, ie incapable of propagating flame.’ It follows from this that hydrocarbon gas may itself be used for blanketing provided it is deficient in oxygen.

The use of hydrocarbon gas to form a blanket has two important advantages over the use of flue gas. First, it takes up less VOC from the cargo, which therefore holds its value better. And second, it is less corrosive than flue gas, so the working life of the oil handling facility is prolonged.

The present invention accommodates hydrocarbon gas blanketing.

Thus according to a sixth aspect the invention provides a method of handling cargoes of liquid hydrocarbon in which:

the liquid hydrocarbon is loaded into a tank and subsequently offloaded from the tank;

during offloading the tank is backfilled with inert hydrocarbon gas to form a blanket; and

during loading the blanket gas is vented from the tank;

characterised in that said method comprises burning the vented blanket gas undissociated and in gaseous form to provide a source of heat energy.

The hydrocarbon gas may be extracted from crude oil and the liquid hydrocarbon to be loaded in the tank may be extracted from the crude oil and separated from the hydrocarbon gas.

The invention extends to apparatus for treating vent gas from a tank of liquid hydrocarbon, which vent gas comprises a mixture of inert hydrocarbon gas and VOC and is vented from a top of the tank, characterised in that said apparatus comprises:

a supply means operative to supply hydrocarbon gas and liquid hydrocarbon;

a hydrocarbon gas conduit connected to the supply means to receive the hydrocarbon gas;

a liquid hydrocarbon conduit connected between the supply means and the tank for loading the liquid hydrocarbon into the tank;

a blanket gas transfer conduit connected to the top of the tank;

a blanket gas supply conduit connected between the hydrocarbon gas conduit and the blanket gas transfer conduit thereby to supply hydrocarbon gas to the tank to form a blanket over the oil therein;

a burner;

a vent gas supply conduit connected between the blanket gas transfer conduit and the burner to deliver to the burner blanket gas vented during loading of the liquid hydrocarbon; and

a fuel gas supply conduit connected between the hydrocarbon gas conduit and the burner to deliver hydrocarbon gas to the burner as fuel gas;

wherein the burner is configured and arranged to burn the fuel gas during offloading of the liquid hydrocarbon from the tank and to burn the fuel gas and/or the vented blanket gas during loading of the liquid hydrocarbon into the tank.

Heat from burning the fuel gas and/or the vented blanket gas may be used (eg through the generation of steam) for a variety of purposes including heating the liquid hydrocarbon in the tank to combat waxiness. And during offloading, the heat may be used to drive a pump for offloading the liquid hydrocarbon.

The invention will now be described by way of example only with reference to the accompanying drawings which are purely schematic and not to scale and in which—

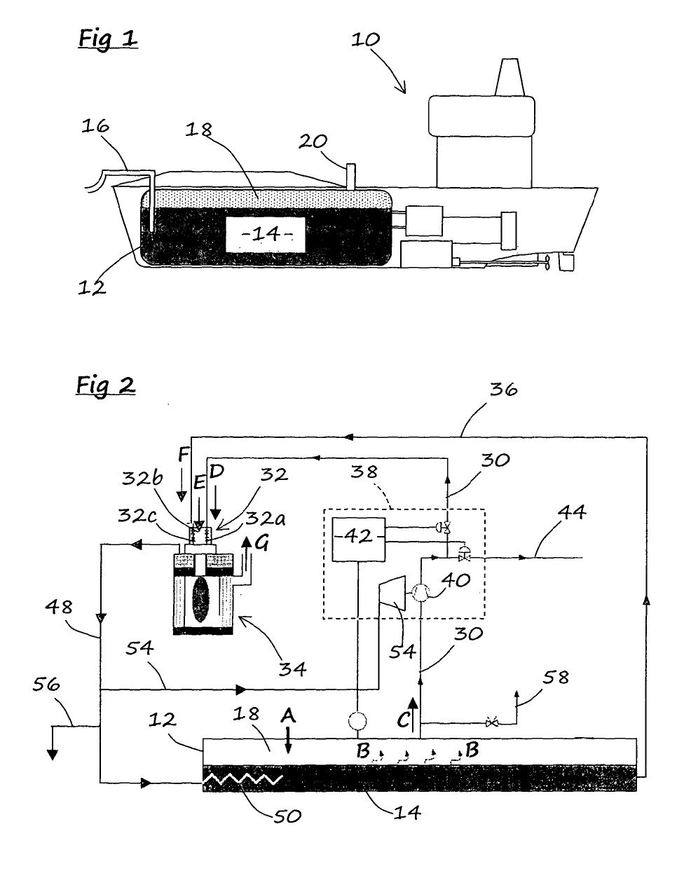

FIG. 1 shows an oil tanker in side elevation and illustrates the background to the invention;

FIG. 2 illustrates a first embodiment of a system for treating vent gas according to the invention;

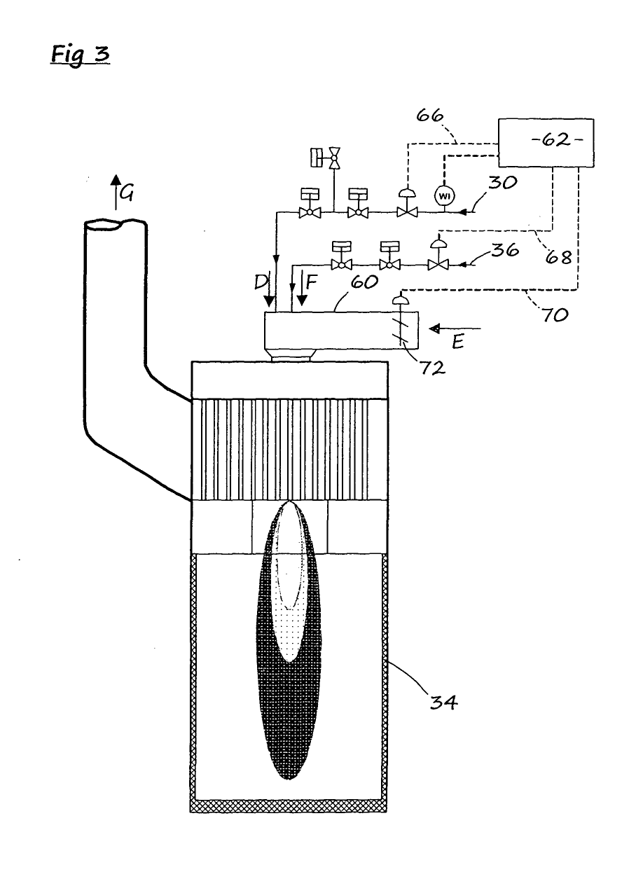

FIG. 3 illustrates a burner control system for use with the system of FIG. 2;

FIG. 4 is a schematic illustration of a burner for the system, in plan view;

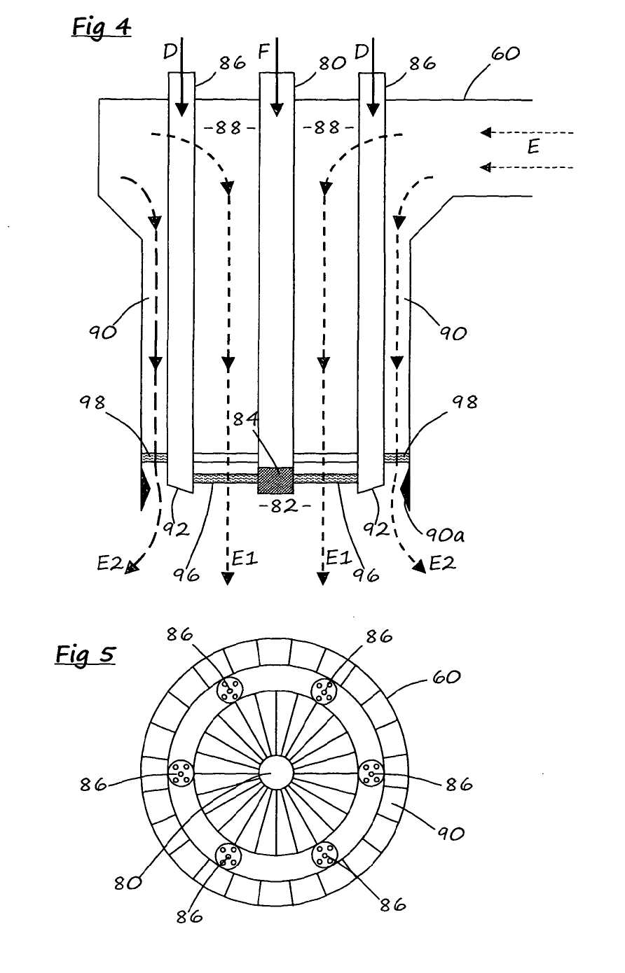

FIG. 5 is a front elevation corresponding to FIG. 4; and

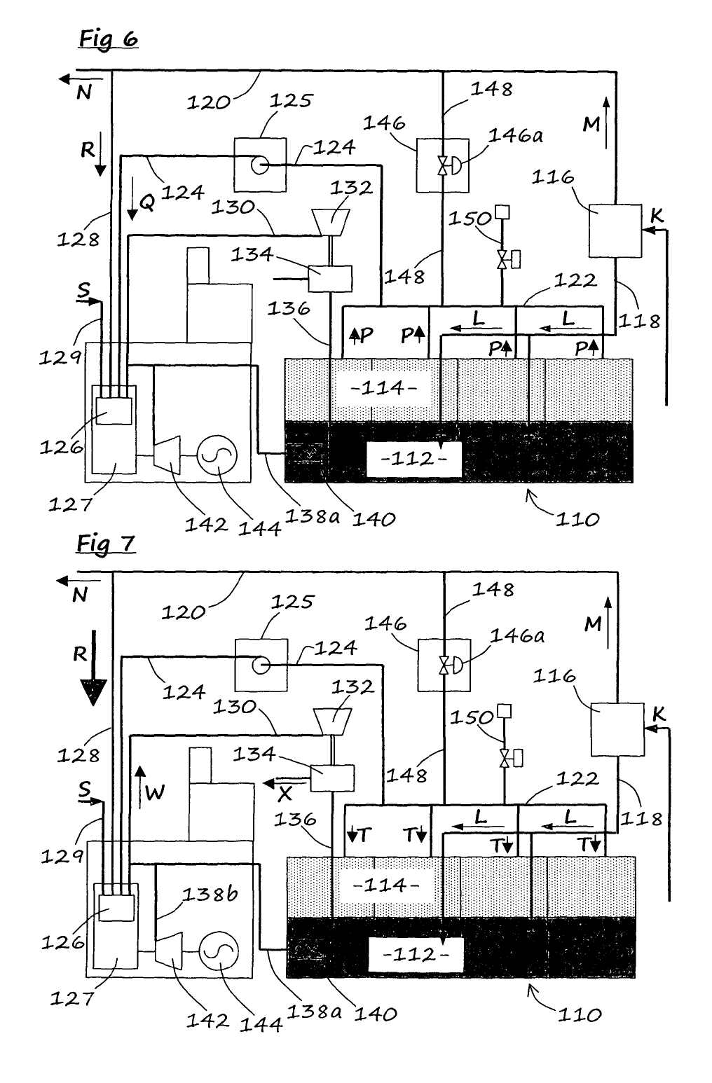

FIGS. 6 and 7 illustrate another embodiment of a system for treating vent gas according to the invention, during loading and offloading respectively.

The invention is hereinafter described with particular reference to its use on board a tanker being loaded with crude oil but for the avoidance of doubt it should be noted that the invention is not so limited. For instance, the invention may be used to treat gas vented from the cargo tanks while the tanker is in transit and is subjected to roll, surge and pitch etc. Further, whilst the invention has particular benefits in relation to the handling of light crude oil, it may well be of use in handling refined oil or heavier crude oil. And in addition the invention may be used on FSO or FPSO facilities as well as tankers, or possibly in connection with land-based oil storage facilities.

Referring first to FIG. 1, this shows an oil tanker 10 having a cargo tank 12 being filled with crude oil 14 by means of an oil line 16. To counter the risk of fire or explosion during the loading operation, the tank 12 is prefilled with an inert gas (which may be exhaust gas from onboard equipment) and this forms a gaseous blanket 18 over the oil 14.

The loading operation affects the gaseous blanket 18 in two ways. First, methane and other VOC given off by the oil 14 forms a mixture with the inert gas in the gaseous blanket 18. Second, the gaseous blanket 18 is progressively displaced by the oil and has to be vented by way of a vent 20. Those skilled in the art will understand that, as well as creating a risk of fire or explosion, the VOC is environmentally damaging (methane, especially, and hydrogen sulphide which may also be present) and a potentially valuable resource which should not be wasted. For all these reasons it is clearly not acceptable for the gas from the vent 20—ie the vent gas—to be released into the atmosphere, particularly at the rate it is displaced by the incoming oil, which is typically 1000 m³/hr upwards.

The present invention treats the vent gas so that it is used profitably as well as being withheld from the atmosphere, as will be described in more detail hereinafter with reference to FIG. 2.

First, however, another problematic aspect of the oil loading operation should be noted. This is that crude oil is commonly waxy, which means that at regular temperatures paraffin hydrocarbons and/or naphthenic hydrocarbons contained in the oil tend to solidify and make it difficult to pump the oil. This problem can be overcome by heating the oil.

Referring now to FIG. 2, the cargo tank 12 is being loaded with crude oil 14 as indicated by arrow A. As indicated by arrows B the oil 14 gives off VOC which mixes with the inert gas blanketing the oil 14. Thus the gas 18 in the cargo tank 12 is a mixture of inert gas and VOC, the respective proportions of which vary—in particular, with a relatively small amount of VOC in a large volume of inert gas at the beginning of the loading operation and with an increasing proportion of VOC as loading proceeds.

As the oil is loaded at A, the gas mixture 18 displaced by it is vented as indicated at C into a gas conduit 30 extending from the tank 12 to one fuel injector 32a of a dual-fuel burner 32 arranged so that the vent gas 18 delivered thereto as indicated by arrow D will fire a boiler 34 in the presence of combustion air admitted to the boiler 34 by way of an air conduit 32b as indicated by arrow E. An oil conduit 36 extends from the tank 12 to the second fuel injector 32c of the burner 32 to deliver oil 14 to the burner 32, as indicated by arrow F, as a supplementary fuel therefor.

The gas conduit 30 extends from the tank 12 to the burner 32 by way of a compressor module indicated in broken lines at 38. This compressor module 38 includes a compressor 40 which compresses the vent gas in the gas conduit 30 to a gauge pressure of 3 bar, but it should be noted that the vent gas is not dissociated and it remains in gaseous form: that is, the vent gas components (methane, NMVOC, hydrogen sulphide, carbon dioxide etc) are not separated, and none of the vent gas is liquefied. The compressor module 38 also includes a controller 42 connected to both the tank 12 and the gas conduit 30, whereby pressure in the tank 12 is controlled. Within the compressor module 38, and also connected to the controller 42, a return conduit 44 branches off from the gas conduit 30, whereby compressed vent gas may be delivered for reabsorption into the oil.

When the boiler 34 is fired it generates steam which is delivered by way of a steam line 48 to a heater 50 in the tank 12, whereby the oil 14 is heated to counter waxiness thereof. An ancillary steam line 52 allows steam from the boiler to be delivered to a steam turbine 54 arranged to drive the compressor 40 (which may alternatively be driven by some other means such as an electric motor). A further ancillary line 56 allows steam to be drawn off for other purposes such as electrical power generation.

The overall operation of the system shown in FIG. 2 can now be summarised as follows. Crude oil is loaded into the tank 12 at A and vent gas comprising a mixture of VOC and inert gas is vented from the tank 12 at C and compressed (but not dissociated or liquefied) and at least some of the compressed vent gas is delivered at D to the dual-fuel burner 32 of the boiler 34. The burner 32 also receives, at F, a supply of oil 14 as a support fuel. The burner 32, which will be described in more detail hereinafter in relation to FIG. 3, is configured and controlled so that oil—or other fuel—supplied as a support fuel provides stable combustion by being adjusted automatically according to the Wobbe Index and flow rate of the vent gas supplied to it. (The Wobbe Index is a measure of the calorific value or “heating content” of a fuel and various known meters are known for determining this). Thus the amounts of vent gas at D and oil at F are relatively adjusted, in particular to allow for varying proportions of VOC in the vent gas. Steam generated in the boiler 34 is then used to heat the oil 14, to facilitate its being pumped, or for other purposes.

The exhaust from the boiler 34 is released into the atmosphere at G, the harmful components of the vent gas having been safely converted by burning. (In particular, methane is converted to carbon dioxide plus water, and any hydrogen sulphide is converted to sulphur dioxide plus water). In addition, whilst it is necessary to provide the gas conduit 30 with a vent riser 58, to guard against excess pressure in the tank 12, in normal operation this will not release any VOC to the atmosphere.

The economic value of the vent gas, which may be 0.15% of a tanker's cargo, means it is desirable to reabsorb as much as possible into the oil. However at certain times, especially during loading, the reabsorption system may not be able to cope with the rate at which vent gas is displaced—1000 m³ upwards. Thus, even where it is preferred to reabsorb the vent gas, the present invention is valuable in dealing with excess quantities of vent gas, in addition to its intrinsic benefits in extracting energy from vent gas.

The way in which combustion of the vent gas is controlled will now be described with reference to FIG. 3, which shows the boiler 34 fired by a burner of which the supply manifold 60 is partly visible in the drawing, under the control of an automatic combustion control system 62.

The flow arrows shown in FIG. 3 have the same signification as in FIG. 2, and where appropriate the reference numerals correspond. Thus vent gas is delivered to the manifold at D from a gas conduit 30, oil (or possibly some other support fuel to stabilise the combustion) is delivered at F from an oil conduit 36 and combustion air is delivered at E.

The combustion control system 62 receives, by way of a gas monitoring line 64, measurements of the Wobbe Index and flow rate of the vent gas in the gas conduit 30. From these measurements the heat input to the boiler 34 from combustion of the vent gas is determined. The oil burned in the burner supplements the heat input from the vent gas, to provide a desired amount of steam at all times. The combustion control system 62 operates automatically to supply oil at a rate related to the measured Wobbe Index and flow rate of the vent gas. The combustion control system 62 is arranged so that at all times when the boiler is operational the oil delivery rate somewhat above the minimum value required to supplement the vent gas. Thus the combustion control system 62 controls, by way of control lines 66 and 68, valves in the gas and oil conduits 30 and 36 to adjust the relative supplies of gas and oil automatically.

By way of a further control line 70 the combustion control system 62 also adjusts a damper 72 so that the amount of combustion air E supplied is somewhat above that required for stoichiometric combustion of the vent gas D and oil F in the boiler 34. Accordingly the combustion products exhausted from the boiler 34 at G can be released to the atmosphere without major environmental hazard, being substantially less damaging to the environment than untreated vent gas: in particular substantially all methane in the vent gas D is converted to carbon dioxide plus water and substantially all hydrogen sulphide (if present) in the vent gas DJs converted to sulphur dioxide plus water.

The oil F also provides stable combustion. When it burns it produces a core flame which (a) provides a source of ignition for the vent gas D and (b) maintains a temperature at the firing end of the burner which is sufficient to ensure oxidation of the hydrocarbon components of the vent gas D—ie stable combustion.

The burner manifold 60 is shown in more detail in FIGS. 4 and 5, respectively in plan and front elevation views. The oil F is delivered to a central, support fuel passage 80 which extends axially to a firing end 82 where there is an igniter (not shown, which may be of known construction). The support fuel passage 80 includes at the firing end a steam atomiser 84 which may be of known construction. The vent gas D is delivered to a gas passage comprising a plurality of axially extending gas ducts 86 spaced circumferentially about the support fuel passage 80. Combustion air delivered at E is divided into separate primary and secondary air streams, E1 and E2, the primary air E1 passing through a primary air passage 88 of annular form between the support fuel passage 80 and the gas ducts 86 and the secondary air E2 passing through a secondary air passage 90 of annular form circumjacent the gas ducts 86. Towards the firing end 82 the secondary air passage 90 is formed as indicated at 90a to allow the forwardly-flowing secondary air E2 to diverge outwards, ie away from the axis of the manifold 60, and each of the gas ducts 86 is formed as indicated at 92 with a plurality of nozzles inclined so as to face forwards and outwards. The primary air passage 88 has vanes 96 at the firing end 82 and the secondary air passage 90 has vanes 98 at the firing end 82, whereby both the primary and secondary air streams E1 and E2 are swirled about the axis of the manifold 60 on exit therefrom.

As will be understood from the foregoing description with reference to FIG. 3, the amount of combustion air E supplied is automatically adjusted to ensure not less than stoichometric combustion and the relative proportions of vent gas D and oil F delivered to the burner manifold 60 are automatically adjusted to provide stable combustion. The form of burner shown in and described with reference to FIGS. 4 and 5, under the control of the combustion control system 62 of FIG. 3, allows effective combustion of gases across a range of Wobbe Index from 10 MJ/Nm³ to 70 MJ/Nm³.

FIGS. 6 and 7 illustrate the adaptation of the invention to treat gas vented from a tank for oil (or other liquid hydrocarbon) in which hydrocarbon gas is used for blanketing oil in the tank, rather than an exhaust gas mixture or some other inert gas.

The system shown in FIGS. 6 and 7 comprises a plurality of interconnected tanks 110 on an FPSO (not detailed). The tanks 110 contain processed oil 112 blanketed with hydrocarbon gas 114. As will be readily understood by those skilled in the art, the hydrocarbon gas 114 contains insufficient oxygen (if any) to support the propagation of flame. The hydrocarbon gas 114 thus constitutes inert gas meeting the requirements of the International Maritime Organisation and the SOLAS Convention.

Crude oil from a well or other facility is delivered at K to an onboard crude oil processing unit 116 which by means well known separates it into liquid processed oil and gaseous hydrocarbon gas and thereby provides supply means for liquid hydrocarbon and hydrocarbon gas. The processed oil 112 is delivered at L into the tanks 110 by way of a liquid hydrocarbon conduit 118 connected between the processing unit 116 and the tanks 110. The hydrocarbon gas is delivered at M to a hydrocarbon gas conduit 120 from where it may be drawn off at N for sale and also (as will be described in more detail hereinafter) used in the system.

A blanket gas transfer conduit 122 comprising a plurality of lines is connected to the tops of the tanks 110. A vent gas supply conduit 124 containing a vent gas blower 125 extends between the blanket gas transfer conduit 122 and a burner 126 in a boiler 127 (not otherwise detailed). The burner 126 is of the kind hereinbefore described with reference to FIGS. 3 to 5. The burner 126 is also connected to the hydrocarbon gas conduit 120 by way of a fuel gas supply conduit 128 and to a fuel oil line 129.

A first steam line 130 extends from the boiler 127 to a first turbine 132 operative to drive a pump 134 for offloading oil 112 by way of an oil offloading conduit 136 extending into the tanks 110. A second steam line 138 extends from the boiler 127 and includes a heater branch 138a to a heater 140 arranged in the bottom of the tanks 110 to heat the oil 112 to counteract any waxiness thereof and a supplementary branch 138b to supplementary apparatus such as a second turbine 142 driving an electrical generator 144. In this way heat from burning the hydrocarbon gas serves a range of needs onboard the FPSO.

A hydrocarbon gas blanketing unit 146 including a blanketing valve 146a is connected by a blanket gas supply conduit 148 to the hydrocarbon gas conduit 120 on one side and, on the other, to the tanks 110 by way of the blanket gas transfer conduit 122.

A vent gas riser 150 extends upwards from the blanket gas transfer conduit 122. The vent gas riser 150 normally remains closed, the system being arranged to avoid the need to discharge vent gas to atmosphere.

The operation of the system of FIGS. 6 and 7 will now be described, first during loading with reference to FIG. 6.

During loading, crude oil is supplied at K to the processing unit 116, which separates the crude oil into hydrocarbon gas and processed oil. (It will be understood that the processing unit may also extract water, sand/mud, hazardous chemicals and other unwanted components of the crude oil). The processed oil output from the processing unit 116 is delivered at L into the oil tanks 110 by way of the liquid hydrocarbon conduit 118.

As the oil enters the tanks 110 during the loading phase it drives out the hydrocarbon blanket gas 114 from the tanks, through the blanket gas transfer conduit 122, as indicated in FIG. 6 by arrows P. This vented blanket gas, which contains a small proportion of VOC, is fed to the burner 126 by the vent gas blower 125, through the vent gas supply conduit 124, as indicated by arrow Q. At the same time, hydrocarbon gas (not containing VOC) tapped from the hydrocarbon gas conduit 120 is supplied to the burner 126 by way of the fuel gas conduit 128, as indicated by arrow R. In addition the burner 126 has a supply of fuel oil at S, to provide a support fuel if required.

Thus during loading the burner 126 burns vented blanket gas containing VOC, hydrocarbon gas not containing VOC and (if required) fuel oil and thus the boiler 127 produces steam that can be utilised onboard the FPSO for a variety of purposes including heating the oil 112 to counteract any waxiness. Burning the vented blanket gas means that it does not have to be discharged to atmosphere, which is environmentally damaging and forbidden in some jurisdictions. The use of hydrocarbon gas from the conduit 120 is minimised, so the amount of hydrocarbon gas available for sale or other uses is maximised. Finally, during loading the hydrocarbon gas blanketing unit 146 is inoperative and the blanket gas valve 146a is closed, so the hydrocarbon gas in the conduit 120 is not contaminated with VOC from the vented blanket gas.

Considering offloading now, with reference to FIG. 7, the hydrocarbon gas blanketing unit 146 is operative and the blanket gas valve 146a is open. By this means hydrocarbon gas from the conduit 120 is delivered through the blanket gas supply conduit 148 to the blanket gas transfer conduit 122 and from there to the tanks 110, as indicated by arrows T. During this offloading phase, the vent gas blower 125 is inoperative and the vent gas supply conduit 124 is closed, so there is no route for air/oxygen into the blanket gas, which would compromise its blanketing capability. There is also no loss of blanket gas from the blanket gas transfer conduit 122 to the burner 126, which would limit the rate at which the tanks 110 could be backfilled with blanket gas, and in turn limit the rate at which the oil 112 could be offloaded.

Generally oil needs to be offloaded from an FPSO as quickly as possible (and much faster than the usual loading rate) to minimise the unproductive turnaround time of the tanker receiving the oil. Therefore the pump 134 must be large and powerful. Accordingly, during offloading a larger amount of hydrocarbon gas is drawn off from the conduit 120 to fuel the boiler 127, as indicated in FIG. 7 by the enlarged arrow R, and is supplemented by fuel oil at S. During offloading the boiler 127 generates steam which, as well as optionally being used to heat the oil and power other facilities, is supplied to the first turbine 132 by way of the first steam line 130, as indicated by arrow W. The first turbine drives the pump 134 to offload the oil as indicated at X.

Thus during offloading the burner 126 burns substantially pure hydrocarbon gas which, supplemented by fuel oil as required, provides enough energy to run the pump 134 at high capacity, for rapid offloading. At the same time the tanks 110 are backfilled with substantially pure hydrocarbon gas, as a blanket of inert gas within the criteria defined by the International Maritime Organisation and the SOLAS Convention. The vent riser 150 remains closed, so there is no environmentally damaging discharge of VOC or other hydrocarbon gas to atmosphere. And finally the flow of blanket gas towards the tanks 110 during offloading prevents contamination of the hydrocarbon gas conduit with VOC, so the value of the separated hydrocarbon gas is sustained.

Variations on the embodiment of the invention particularly described hereinbefore will be apparent to those skilled in the art, and four points may be noted in particular. First, the generation of steam to heat the oil is likely to be of particular benefit in high-rate offloading and where the oil is so waxy as to require heating (which, in the absence of the invention, would demand consumption of additional fuel oil or fuel gas), but as indicated steam so produced may be used for other purposes. Second, heat output from burning the vented gas (with oil or other supplementary fuel) may have other applications such as space heating. Third, in any event the invention provides a means whereby the resource bound up in the vent gas can be utilised economically, without the cost and complexity of separation and liquefaction found necessary in the prior art. And fourth, the invention is applicable to FSO and FPSO facilities and to tankers and may also be of use in land-based storage facilities.

It should also be noted that the invention is not necessarily limited to use while loading or offloading oil. Any liquid hydrocarbon gives off VOC, in storage or in use or in production, and whenever there is a pressure increase there is a need for gas to be vented. The invention may be used to treat any such vent gas at any time.

Finally, those skilled in the art will appreciate that where the blanket is formed from exhaust gas or similarly noninflammable gas such as nitrogen gas delivered from a nitrogen generator, over a cargo loading cycle from empty to full the vent gas will range from relatively low combustibility to relatively high combustibility. But even at the higher end, the burning of such vent gas is likely to require a support fuel of oil or gas, the amount of which may vary according to the combustibility of the vent gas. However, where the blanket is formed from hydrocarbon gas, as supplied from a crude oil processing unit onboard an FPSO or from a subsea gas supply pipeline to an FSO, the vent gas will be 100% hydrocarbon and therefore of very high combustibility (and calorific value). The burning of such vent gas will not require a support fuel. In short, where hydrocarbon gas is used for blanketing, the vented gas can be burned without a support fuel, whereas the use of other inert gas for blanketing may require the use of a support fuel.

1-40. (canceled)

41. A method of treating vent gas from a store containing a cargo of liquid hydrocarbon blanketed with inert blanket gas wherein the liquid hydrocarbon is loaded to and offloaded from said store and wherein the vent gas comprises a mixture of the blanket gas and VOC given off by the liquid hydrocarbon, in varying proportions, comprising burning the vent gas displaced from the store during loading undissociated and in gaseous form to provide heat.

42. A method of treating vent gas from a store containing a cargo of liquid hydrocarbon as claimed in claim 41 characterised in that said heat is utilised to heat and/or to pump the cargo.

43. A method of treating vent gas from a store containing a cargo of liquid hydrocarbon as claimed in claim 41 characterised in that the vent gas is burned in a burner together with support fuel providing stable combustion.

44. A method treating vent gas from a store containing a cargo of liquid hydrocarbon as claimed in claim 43 characterised in that the support fuel comprises a quantity of the liquid hydrocarbon.

45. A method of treating vent gas from a store containing a cargo of liquid hydrocarbon as claimed in claim 43 characterised in that the quantity of support fuel is adjusted automatically according to the Wobbe Index and flow rate of the vent gas.

46. A method of treating vent gas from a store containing a cargo of liquid hydrocarbon as claimed claim 43 characterised in that the vent gas is burned in the presence of combustion air supplied in an amount not less than that required for stoichiometric combustion whereby the vent gas is burned so as to produce combustion products which are substantially less damaging to the environment than untreated vent gas.

47. A method of treating vent gas from a store containing a cargo of liquid hydrocarbon as claimed in claim 46 characterised in that in burning the vent gas substantially all methane in the vent gas supplied to the burner is converted to carbon dioxide plus water and substantially all hydrogen sulphide in the vent gas supplied to the burner is converted to sulphur dioxide plus water and substantially all toxic components of the vent gas are incinerated.

48. A method of treating vent gas from a store containing a cargo of liquid hydrocarbon as claimed in claim 41 characterised in that the vent gas is compressed before being burned and VOC in the compressed vent gas is reabsorbed into the liquid hydrocarbon by vapour absorption.

49. A method of treating vent gas from a store containing a cargo of liquid hydrocarbon as claimed in claim 41 in which the blanket gas comprises hydrocarbon gas.

50. A method of treating vent gas from a store containing a cargo of liquid hydrocarbon as claimed in claim 49 characterised in that the liquid hydrocarbon and the hydrocarbon gas are extracted from crude oil and mutually separated.

51. Apparatus for treating vent gas from a store containing a cargo of liquid hydrocarbon blanketed with inert blanket gas wherein the liquid hydrocarbon is loaded to and offloaded from the store and wherein the vent gas comprises a mixture of the blanket gas and VOC given off by the liquid hydrocarbon, in varying proportions, comprising:
a burner operative to burn the vent gas undissociated and in gaseous form together with a support fuel providing stable combustion,
a gas conduit for supply of the undissociated vent gas to the burner,
a support fuel conduit for supply of the support fuel to the burner, and
an air conduit arranged to supply combustion air to the burner for combustion of the undissociated vent gas with the support fuel.

52. Apparatus for treating vent gas from a store containing a cargo of liquid hydrocarbon as claimed in claim 51 characterised in that the support fuel conduit is arranged to supply a quantity of the liquid hydrocarbon to the burner as the support fuel.

53. Apparatus for treating vent gas from a store containing a cargo of liquid hydrocarbon as claimed in claim 51 characterised in that said apparatus comprises a supply means operative to extract hydrocarbon gas from crude oil to leave the liquid hydrocarbon and a hydrocarbon gas conduit means connected to the supply means to receive hydrocarbon gas and deliver it to the store as a blanket over the liquid hydrocarbon therein.

54. Apparatus for treating vent gas from a store containing a cargo of liquid hydrocarbon as claimed in claim 51 characterised in that the apparatus includes burner control means operative automatically to adjust the amount of the support fuel supplied to the burner according to the Wobbe Index and flow rate of the vent gas.

55. Apparatus for treating vent gas from a store containing a cargo of liquid hydrocarbon as claimed in claim 51 characterised in that apparatus includes a compressor operative to compress the vent gas and a return conduit extending from the compressor to a vapour absorption device whereby VOC in the compressed vent gas is reabsorbed into the liquid hydrocarbon.

56. Apparatus for treating vent gas from a store containing a cargo of liquid hydrocarbon as claimed in claim 51 characterised in that said apparatus comprises a boiler fired by means of the burner to generate steam, a gas conduit for supply of undissociated vent gas from the store to the burner to be burned therein, a liquid hydrocarbon conduit for supply of liquid hydrocarbon to the burner to be burned therein and provide stable combustion for the vent gas, an air conduit arranged to supply combustion air to the burner for combustion of the undissociated vent gas with the liquid hydrocarbon, and a steam conduit extending from the boiler to heat the cargo.

57. Apparatus for treating vent gas from a store containing a cargo of liquid hydrocarbon as claimed in claim 51 wherein the blanket gas comprises hydrocarbon gas and the vent gas is vented from a top of the store, characterised in that said apparatus comprises:
a supply means operative to extract the hydrocarbon gas from crude oil to leave the liquid hydrocarbon;
a hydrocarbon gas conduit connected to the supply means to receive the hydrocarbon gas;
a liquid hydrocarbon conduit connected between the supply means and the tank for delivering the liquid hydrocarbon to the store;
a blanket gas transfer conduit connected to the top of the store
a blanket gas supply conduit connected between the hydrocarbon gas conduit and the blanket gas transfer conduit thereby to supply hydrocarbon gas to the store to form a blanket over the liquid hydrocarbon therein;
a burner;
a vent gas supply conduit connected between the blanket gas transfer conduit and the burner to deliver to the burner vent gas vented from the store during loading of the liquid hydrocarbon; and
a fuel gas supply conduit connected between the hydrocarbon gas conduit and the burner to deliver hydrocarbon gas to the burner as fuel gas.

58. Apparatus for treating vent gas from a store containing a cargo of liquid hydrocarbon as claimed in claim 57 characterised in that said apparatus includes a steam generator heated by burning the fuel gas and the vent gas.

59. Apparatus for treating vent gas from a store containing a cargo of liquid hydrocarbon as claimed in claim 58 characterised in that said apparatus includes a heater in the store heated by steam from the steam generator.

60. Apparatus for treating vent gas from a store containing a cargo of liquid hydrocarbon as claimed in claim 58 characterised in that the apparatus includes a pump for offloading the liquid hydrocarbon from the store, which pump is powered by steam from the steam generator.
